(19) United States
(12) Patent Application Publication
(10) Pub. No.: US 2026/0165262 A1
(43) Pub. Date: Jun. 18, 2026

(54) METHOD, APPARATUS AND SYSTEM FOR DELIMBING A TREE FROM AIR

(71) Applicant: AIRFORESTRY AB, Uppsala (SE)

(72) Inventor: Johan NORDKVIST, Västra Frölunda (SE)

(21) Appl. No.: 19/128,381

(22) PCT Filed: Oct. 23, 2023
(86) PCT No.: PCT/SE2023/051044

§ 371 Date: May 8, 2025

(30) Foreign Application Priority Data
Nov. 11, 2022 (SE) 2251319-6

(51) Int. Cl. A01G 23/083; B64D 1/22; B64U 10/16; B64U 101/40; B64U 101/67

(52) U.S. Cl. CPC A01G 23/083; B64D 1/22; B64U 10/16; B64U 2101/40; B64U 2101/67; B64U 2201/20

(57) ABSTRACT

The present invention relates to a system (10) for remotely and/ or autonomously delimbing a tree from air, said system (10) comprising: a drone; a harvesting tool (105,110) comprising movably delimbing means configured for delimbing at least a portion of a tree; a cord (560) attached underneath said drone to said harvesting tool (105,110); a winch system (570), attached to said drone and/or said harvesting tool (105,110), configured for spooling in and/or out said cord (560) and thereby decreasing or increasing the distance between said drone and said harvesting tool (105,110); a base station (120) configured for communicating with said drone and/or said harvesting tool (105,110); a sensor attached to said drone and/or said harvesting tool (105,110) for detecting a tree; a cord attachment point provided on said harvesting tool (105,110), wherein said attachment point is movable between at least a first and second position.

### TECHNICAL FIELD OF THE INVENTION

The present invention relates in general to a system for tree harvesting, in particular it relates to a system for delimbing a tree by using an Unmanned Aerial Vehicle, UAV and a harvesting tool configured for delimbing a tree attached to said UAV. The invention also relates to a method for delimbing a tree by using said system, a computer-implemented method for remotely and/or autonomously delimbing a tree from air and a computer program comprising program code means for performing a delimbing method.

### BACKGROUND OF THE INVENTION

Traditional tree harvesting or tree falling has long been conducted by persons and equipment based on the ground. In earlier times, from the early twentieth century and going back to the early nineteenth century, little consideration was given to the state of the forest or to the eco-system within the forest. Logging was done on a massive scale to keep up with the demand caused by the industrial revolution and the subsequent expansion of human life at the time. Depending on the terrain, tree harvesting process usually begins with experienced tree fellers cutting down a stand of trees or by using heavy ground based manned harvesting machines. The above-described methods represent a high level of risk, either to the environment or the people performing the work. Damage can also be done to the delicate ecology of the forest, known as the understory or underbrush, where smaller plants bind the soil together and provide a habitat to insects, birds, lichens, and fungus among other things.

Most importantly, many locations are extremely difficult to reach by land, even with the use of heavy equipment such as bulldozers, and removal of trees from such locations is expensive. Sometimes it may be desirable to harvest a single tree amongst a stand of trees, so called tree thinning, without disturbing the surrounding trees.

In U.S. Pat. No. 6,263,932 it is disclosed an aerial tree harvesting apparatus. A first body of said apparatus is suspended from an ordinary helicopter and a second body is suspended by cables from the first body. The apparatus is capable of delimbing and cutting the tree and thereafter transporting the harvested tree to another location.

The problem with U.S. Pat. No. 6,263,932 is that delimbing may require unnecessary amount of time, man hours and/or unnecessary amount of power due to inefficient delimbing technique. Another problem with U.S. Pat. No. 6,263,932 is that it requires a complicated harvesting tool with a first and second separable bodies connected to each other via a plurality of cables.

### OBJECT OF THE INVENTION

The present invention aims at obviating the aforementioned problem. A primary object of the present invention is to provide an improved remotely and/or autonomously delimbing system and method.

### SUMMARY OF THE INVENTION

According to the invention at least the primary object is attained by means of a system and method as defined in the independent claims.

Preferred embodiments of the present invention are further defined in the dependent claims.

According to a first aspect of the present invention it is provided a system for remotely and/or autonomously delimbing a tree from air, said system comprising:
a remotely and/or autonomously controlled Unmanned Aerial vehicle, UAV,
a harvesting tool comprising a frame structure with at least one movably delimbing means configured for delimbing at least a portion of a tree,
a cord attached between said UAV and said harvesting tool,
a winch system, attached to said UAV and/or said harvesting tool, configured for spooling in and/or out said cord and thereby decreasing or increasing the distance between said UAV and said harvesting tool,
a base station configured for communicating with said UAV and/or said harvesting tool,
a sensor attached to said UAV and/or said harvesting tool for detecting a tree,
an attachment point for said cord provided on a support structure, wherein said support structure is slidably, tiltably or rotatably arranged on an upper portion of said frame structure, said support structure is configured to be slided, tilted or rotated between at least a first position where said attachment point is provided essentially in a mass center and/or in an area above the centre of a tree receiving area of the harvesting tool and a second position where said attachment point is away from said mass center and/or away from said area above the tree receiving area of the harvesting tool, wherein the tree receiving area refers to an area in between open or closed delimbing means and said frame structure.

The advantage of this embodiment is that it provides for a system for deliming a standing tree from above in which only a single cord is used between the UAV and the harvesting tool.

In various example embodiments of the present invention said tree receiving area is configured to be set in an open position when above the top of a tree and configured to be set in a closed position when said harvesting tool is below the top of the tree. The advantage of these embodiments is that the attachment from above may be easier with a larger tree receiving area.

In various example embodiments of the present invention said support structure is configured to be moved from said first to said second position when said tree receiving area is changed from an open to a closed position.

The advantage of these embodiments is that the trigger for the tree receiving area is synchronized with the movement of the support structure.

In various example embodiments of the present invention said harvesting tool is configured to delimb the tree by gravity.

The advantage of these embodiments is that there is only passive means for delimbing which require a minimum of service and energy.

In various example embodiments of the present invention said harvesting tool comprises means for cutting a tree trunk. Said delimbing means may be at least one of the group of: a knife, a chain saw or a saw blade.

The advantage of these embodiments is that the tree can be cut after it has been delimbed by one and the same tool.

In various example embodiments of the present invention the single cord is at least one of a group of: steel wire, steel band or artificial fiber thread.

The advantage of these embodiments is that different materials of the cord may be used depending on the weight of the harvesting tool and if said harvested tree is to be transported away from the original location.

In another aspect of the present invention it is provided a method for remotely and/or autonomously delimbing a tree from air, said method comprising the steps of:
detecting a tree to be delimbed by a sensor provided on a remotely and/or autonomously controlled Unmanned Aerial vehicle, UAV;
providing a remotely and/or autonomously controlled harvesting tool attached underneath said UAV via a cord, said harvesting tool comprising a tree receiving area configured for being set in an open position when above a top the tree to be delimed and configured for being set in a closed position when said harvesting tool is below said top of the tree to be delimed, wherein the tree receiving area refers to an area in between open or closed delimbing means and a frame structure of said harvesting tool ;.
providing a winch system to said UAV and/or said harvesting tool, configured for spooling in and/or out said cord attached between said UAV and said harvesting tool for decreasing or increasing the distance between said UAV and said harvesting tool,
moving a support structure, provided on said harvesting tool, comprising an attachment point for said cord, between at least a first and second position depending on the relative position between the top of a tree to be delimbed and said harvesting tool and/or depending on a vertical speed of the harvesting tool.

The advantage of these embodiments is that it provides for a method for delimbing a standing tree from above in which only a single cord is used between the UAV and the harvesting tool.

In various example embodiments of the present invention said support structure is rotatably, linearly or tiltably movable relative to said harvesting tool.

The advantage of these embodiments is that different mechanical movement of the support structure may be chosen depending on its arrangement on the harvesting tool and/or space requirements in certain directions.

In various example embodiments according to the present invention said support structure is configured for being moved from said first to said second position when said tree receiving area is changed from an open to a closed position.

The advantage of these embodiments is that the movement of the delimbing means and said support structure may be synchronized.

In various example embodiments of the present invention said attachment point is provided essentially in a mass center and/or in an area above the center of the tree receiving area of the harvesting tool when said support structure is in said first position.

The advantage of these embodiments is that the tool is hanging beneath the UAV essentially in a vertical direction which may simplify the attachment to a top of the tree. Another advantage of these embodiments is that the attachment of the tool to the tree top may be independent of the rotation of the harvesting tool.

In various example embodiments of the present invention further comprising the step of cutting a tree trunk by means of a cutting device provided on said frame structure of said tree harvesting tool.

The advantage of these embodiments is that one and the same tool may be used for delimbing and cutting a tree.

In various example embodiment of the present invention the method further comprising the steps of: securing said harvesting tool to said cut and delimbed tree and transporting said cut tree away from its original location.

The advantage of these embodiments is that one and the same tool may be used for delimbing, cutting and transporting a tree from air.

The invention also relates to a harvesting tool, A computer program comprising program code means for performing the delimbing method and a computer implemented method for remotely and/or autonomously delimbing a tree from air.

In various example embodiments of the present invention said tree top is detected by means of at least one out of at least three different stereo images.

The advantage of these embodiments is that tree tops may be detected despite larger trees nearby, which may be an obstacle when trying to detect tree tops from certain directions.

In various example embodiments of the present invention, said method further comprising the step of detecting with at least one detector a portion of a tree within said tree receiving area of said harvesting tool.

The advantage of these embodiments is that switching from said first to second mode may be triggered by the detection of a tree top within the tree receiving area of the harvesting tool.

In various example embodiments of the present invention said support structure may be triggered to be moved from said first to said second position by at least one of the group of following triggers: at a predetermined distance between said UAV and said harvesting tool, when a tree is detected to be within said receiving area of said harvesting tool, a certain speed of said harvesting tool and/or within a predetermined time interval after said harvesting tool is released from said UAV.

The advantage of these embodiments is that one or a plurality of triggers may be used alone or in combination in order to determine when said support structure should be switched from said first to said second position.

In various example embodiments of the present invention said detection of a tree within said tree receiving area of said harvesting tool is made by at least one optical device provided on said UAV and/or said harvesting tool.

The advantage of these embodiments is a redundancy of detection arrangements. Another advantage is that one or a plurality of tree parameters may require a combination of sensors on said UAV and said harvesting tool to safely detect a tree within said tree receiving area.

Further advantages with and features of the invention will be apparent from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 depicts a schematic perspective view of an example embodiment of an inventive system for remotely and/or autonomously delimbing a tree from air capable of performing the inventive method according to the present invention,

FIG. 2-4 depict various steps of the inventive harvesting method according to the present invention,

FIG. 5a-g depict various example embodiments of an inventive harvesting tool, and

FIG. 6 depicts a block diagram illustrating an example of a machine upon which one or more embodiments may be implemented.

### DETAILED DESCRIPTION OF PREFERRED EMBODIMENTS OF THE INVENTION

The word tree used hereinabove and hereinbelow is a generic term for any tree(s) and/or any bush(es).

The word harvesting used hereinabove and hereinbelow is a generic term for removing at least a portion from a tree, i.e., delimbing a tree, cutting a portion of the tree, cutting the full tree and/or removing the tree with at least a portion of its roots from the ground.

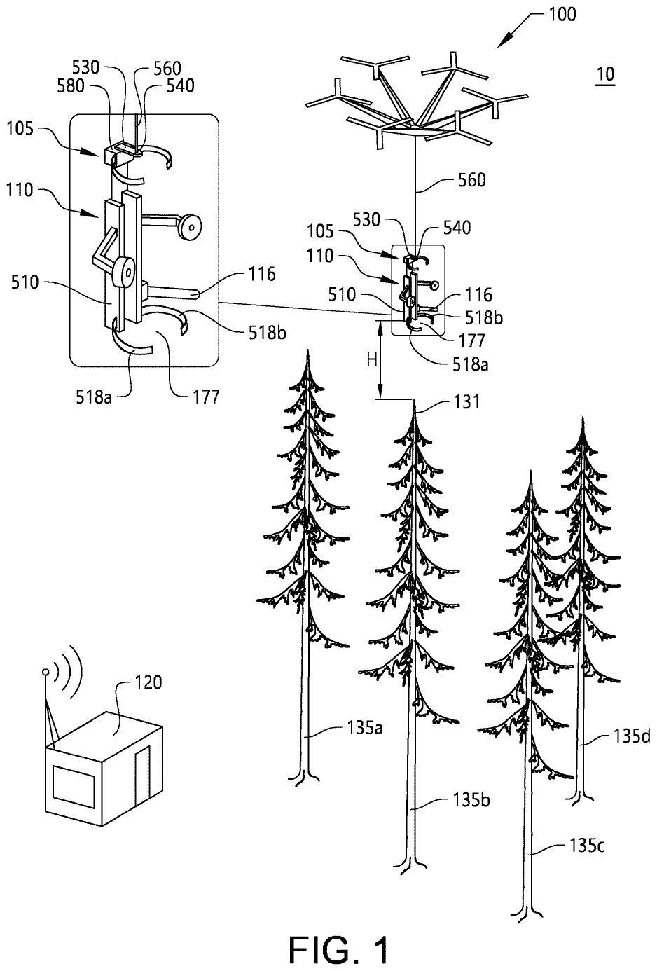

FIG. 1-4, depict schematic pictures of different inventive remote and/or autonomous harvesting steps of at least a portion of a tree by using an example embodiment of an autonomous harvesting system 10. Said system 10 may comprise a remotely and/or autonomously controlled means configured for harvesting and/or transporting at least a portion of a tree 105,110, a remotely and/or autonomously controlled Unmanned Aerial Vehicle 100, UAV. Said system further comprising at least one means for detecting said tree to be harvested and/or transported, and a base station 120 for controlling said means configured for harvesting and/or transporting at least a portion of a tree and said UAV.

Said system 10 may further comprise means for detecting at least one tree parameter of at least a portion of a tree and/or at least one growing condition of at least a portion of a tree. Said system 10 may further comprise means configured for selecting at least a portion of a tree to be harvested and/or transported depending on at least one detected tree parameter and/or at least one detected growing condition of said transported/harvested portion of a tree and/or a remaining portion of a tree and/or of at least one tree grown within a predetermined distance from said transported portion of a tree.

In FIG. 1 said UAV 100 is carrying said remotely and/or autonomously controlled means configured for harvesting at least a portion of a tree 105, 110. The UAV 100 is remotely controlled by said base station 120 and/or autonomously controlled and optionally communicating with base station 120. The base station 120 may be a stationary unit or a mobile unit.

In FIG. 1-4 the UAV 100 can be considered as a forestry forwarder and said means configured for harvesting at least a portion of a tree 105, 110 can be considered to be a forestry harvester.

Said means configured for harvesting at least a portion of a tree 105, 110 may comprise a holding means 105 and a delimbing and cutting means 110. The holding means 105 and said delimbing and cutting means may be one single units or two units capable of being attached and/or separable from each other. The cutting means may be optional meaning that in various example embodiments the means for harvesting at least a portion of a tree 105, 110 has only a delimbing function.

In an autonomously controlled means configured for harvesting at least a portion of a tree said means is able to operate without being controlled directly by humans whereas in a remotely controlled means configured for harvesting at least a portion of a tree said means is able to be operated from a remote distance controlled directly by humans. In various example embodiment said means configured for harvesting at least a portion of a tree and said UAV are remotely controlled. In various example embodiment said means configured for harvesting at least a portion of a tree and said UAV are autonomously controlled. In various example embodiments said means configured for harvesting at least a portion of a tree is remotely controlled and said UAV is autonomously controlled. In various example embodiments said means configured for harvesting at least a portion of a tree is autonomously controlled and said UAV is remotely controlled.

Said means for detecting a tree may be at least one of a camera or an optical sensor. The camera may be at least one of for example an IR-camera (Infrared-camera), NIR-camera (Near Infrared-camera), a VISNIR-camera (Visual Near Infrared-camera), a CCD camera (Charged Coupled Device-camera), a CMOS-camera (Complementary Metal Oxide Semiconductor-camera), a digital camera, a 3D camera e.g., stereo camera, time-of-flight camera or LiDAR. The optical sensor may at least one of a photodetector, pyrometer, proximity detector and/or an infrared sensor.

Said means for detecting a tree may be arranged on said UAV and/or said means configured for harvesting at least a portion of a tree.

In various example embodiments means for detecting at least one of the group of tree parameters may be provided. Said means for detecting at least one of the group of tree parameters may be the same means as being used for detecting a tree and/or an additional means. The additional means may be at least one of a camera or an optical sensor. The camera may be at least one of for example an IR-camera (Infrared-camera), NIR-camera (Near Infrared-camera), a VISNIR-camera (Visual Near Infrared-camera), a CCD camera (Charged Coupled Device-camera), a CMOS-camera (Complementary Metal Oxide Semiconductor-camera), a digital camera, a 3D camera e.g., stereo camera, time-of-flight camera or LiDAR, a spectral camera, a heat sensitive camera, an ultrasonic measurement device, a radar device, a vibration device. The optical sensor may be at least one of a photodetector, pyrometer, proximity detector and/or an infrared sensor. A 3D picture may see through foliage and/or branches. A mean value of multiple 3D images may result in mm precision images. 3D pictures may reveal lots of information about branches, tree trunk and/or tree species. 3D images may be taken from an airborne vehicle such as an UAV. The spectral camera may be used for measuring vegetation index (NDVI), i.e., a measure of the photosynthesis in a particular area. Heat sensitive cameras may be used for measuring the temperature of the surface of the tree trunk which in turn may be a measure of the health of the tree, an insect infestation tree has a higher surface temperature than a non-infested tree. Ultrasonic measurement and/or radar may be used for determining the inner form of the tree, i.e., rotten or hollow inner structure and/or the inner moisture content of the tree. Computer tomography and/or magnetic resonance imaging can give information about a portion of a tree down to a tree cell level. The means for detecting at least one tree parameter may be the same means for detecting if a tree is provided within the tree receiving area of the harvesting tool. In various example embodiments the means for detecting if tree is within the tree receiving area may be different to the means for identifying a tree to be harvested.

Said means for detecting at least one of the group of tree parameters may be a camera or optical sensor in combination with Artificial Intelligence AI. AI may be used for training a model for recognizing one or a plurality of said tree parameters. Tree parameters may be recognized visually and/or by measurement and/or by at least one physical sample. Measurement may be made by optical inspection at a distance from the tree and/or by physical measurement, for instance integrated in said means for gripping/holding 105 said tree trunk. Said means for detecting at least one tree parameter may be a laser scanner attached to said UAV and/or said means for holding said tree trunk and/or said means for harvesting said at least a portion of a tree. By laser scanning the tree trunk the tree species may be determined and other surface conditions of the tree trunk such as the presence of any moss and/or any damage. Detected tree parameters may be compared with stored tree parameters in a database for categorization and/or future choice and/or prioritization. The

If transporting said tree away from its original location a final destination of said at least a portion of the tree may be determined by at least one of said detected tree parameters and/or at least one detected growing condition. Tree parameters can be considered to be intrinsic features and growing conditions can be considered to be extrinsic features.

Tree parameters may for instance be a diameter of said at least a portion of a tree (top diameter, base diameter, mean diameter, median diameter), length of said at least a portion of a tree, tree species of said at least a portion of a tree and/or the weight of said at least a portion of a tree, dry content, age of tree, number of annual rings, distance between annual rings, color of annual rings, width of annual rings, amount of leaves, amount of fir needle, color, chemical composition of the tree, twig-free, deformation(s), cracks (dry cracks (partial or all trough), end crack, ring crack), rootstock, density, rot, discolored, dead tree, insect infested, microorganism infested, weather damage (storm, wind, fire, drought), machine damage (root, tree trunk), amount of fruits, seeds, berries, nuts, cones, flowers on the tree, form of root, root structure, root depth, root volume etc. The color of the tree may be an indicator of tree species. The color may be the color of the outer surface of the tree trunk or the color of a cut area. The form of the tree may be determined by a 3D camera. Form may comprise total volume of tree, leaves or fir needles, deformations, shape deviations etc. Tree parameters may also comprise material properties of the tree such as moisture content (%), tensile strength (MPa), flexural strength (MPa), compressive strength (MPa), shear strength (MPa), impact strength (KJ/m²), hardness (Brinell, Vickers, Rockwell), elasticity module (MPa), thermal conductivity (W/m° C.), heat capacity (J/kg° C.), Calorific value (MJ/kg), etc.

In various example embodiments said tree parameters may be detected manually by human or remote and/or autonomous by a separate unit prior to harvesting. Tree parameters may be stored digitally together with GPS position. In various example embodiments a digital marker may be arranged physically on tree prior to cutting the tree or when the tree is laying on ground. The digital marker may have stored information about at least one tree parameter. The input of tree parameters may be made manually prior to harvesting. The digital marker may be configured to communicate with said UAV. The communication may be performed by Bluetooth, wifi, radio communication and/or telecommunication (3G, 4G, 5G). A physical sample for detecting tree parameters such as density, rot and/or dry content may be made manually prior to harvesting and/or automatically by a sample detection means added to the means for holding the tree trunk and/or the means configured for harvesting at least a portion of a tree. Such sample detection means may be a suitable tool for removing a predetermined amount of the tree to be analyzed.

The removal of said predetermined amount to be analyzed may be made by drilling, sawing or cutting. The analyzation of said predetermined amount of the tree may be made while the UAV is at or near the tree or said predetermined amount of tree may be brought to an analyzation station at a distance from the tree. A selection of where to remove said predetermined amount of the tree may be made by using said camera. Suspected rotten or insect infested area may be detected by the camera and thereafter a sample of such area may be removed and analyzed.

Different portions of a single tree and different tree may be categorized differently depending on the outcome of the analysis, i.e., depending on the tree parameters a specific portion of a tree may fall into one or a plurality of different categories. If a specific portion of a tree may fall in a plurality of different categories a selection may be based on the value or the current demand in the market.

Growing conditions may for instance be #tree per unit area and/or growth potential.

Growing condition may also be biotic environmental factors (interaction of organism of the same species and/or interaction of organisms of other species) such as mount of dead tree/wood within a predetermined area, interaction and/or competition of other species, gas and fragrance from plants, temperature of other plants etc. Fungal infestation and insect infestation may be spread over a large area. It may be advantageous to harvest non infested tree within a predetermined time after having detected an infested tree in a predetermined area. Fungal and insects may spread over several km. Competition for water, nutrition, and sun hours may be within a distance of 0-50 m. Advantageous interaction/competition situations may be made through sorting out plants in predetermined positions in order to get optimal conditions for the remaining ones.

Growing conditions may also be abiotic environmental factors climate (temperature, precipitation etc), topography, ground temperature, geology, hydrology, vegetation, soil, earth deposit, soil depth, surface blockage, minerals, ground carbon contents, ground nitrogen content, ground carbon nitrogen ratio, PH value, bas kat ions, amount of trace elements, physical or chemical erosion, environmental condition, wind etc. Abiotic environmental factors may also be the type of land such as forest land, arable land, agricultural land, natural pasture, mountain impediment, protected area, power line area, military area, built up land etc.

At least one tree parameter and/or growing condition may be used as a factor for determining the usage, demand, storage, quality of the at least a portion of tree. This in turn may be used for determining the final destination of a particular portion of a tree.

Gas sensors may be used to detect water quality (carbon oxide content, methane content, oxygen content etc.).

The UAV may have one or a plurality of propellers. In FIG. 1-4 said UAV has 6 propellers arranged symmetrically around an origin.

The base station 120 may, when remotely controlled, be operated by at least one human being, whereas, when autonomously controlled, may be a base station 120 with programmed software algorithms used for supporting the autonomous UAV and/or the means configured for harvesting at least a portion of a tree. The base station 120 may be a stationary unit or a mobile unit. In various example embodiments said programmed software algorithms used for supporting the autonomous UAV and/or the means configured for harvesting at least a portion of a tree may be directly stored in said UAV and/or said harvesting tool.

Said means for holding the said tree 105 may be at least one movable gripping arm. In various example embodiments said means for holding said tree 105 may be one or a plurality of metal bars which may at least partially penetrate a tree trunk. In various example embodiments said means for holding said tree 105 may be a unit surrounding said tree trunk and being able to change its holding area and thereby compress around the tree trunk for securing purpose and decompress for releasing a tree trunk or entering a tree to be harvested. Said means for holding said tree 105 may comprise said sample detection means.

In various example embodiments said means configured for harvesting at least a portion of the tree may be arranged with means for attaching itself to said tree trunk. In various example embodiments said means configured for harvesting at least a portion of a tree are also configured for moving up and down along the trunk of the tree. The movement may be performed by at least one electrically driven wheel travelling on said tree trunk. In various example embodiments at least one wheel may be electrically driven for enabling movement up and down said tree trunk and at least one other wheel is arranged for friction reduction during said movement. In various example embodiments at least to wheels are configured to attach, secure and move said means configured to harvesting at least a portion of a tree.

In various example embodiments said means configured for harvesting at least a portion of the tree may also be configured for moving on ground. The movement can be made via a plurality of wheels or legs and/or as a tracked vehicle.

Said UAV 100 and said means configured for harvesting at least a portion of the tree may be communicating with each other via one or more of Wifi, Bluetooth, radio communication, telecommunication (3G, 4G, 5G), optical fibre and/or electrical wire. In various example embodiments said control unit and said UAV and/or said means configured for harvesting at least a portion of the tree may be communicating with each other via one or more of Wifi, Bluetooth, radio communication, telecommunication (3G, 4G, 5G). Depending on the distance and/or communication quality between the control unit and said UAV and/or said means configured for harvesting at least a portion of a tree the communication may change from one type of communication to another.

In various example embodiments said means configured for harvesting at least a portion of the tree may be connectable to an underside of said UAV 100.

In various example embodiments the UAV 100 may comprise a power unit for powering said UAV 100 and said delimbing and cutting means 110. The power from said power unit in said UAV 100 may be delivered to said delimbing and cutting means 110 via at least one power cable. The power unit may be an electric motor and/or an internal combustion engine.

In various example embodiments said UAV 100 may comprise at least a first power unit for powering said UAV 100 and said delimbing and cutting means 110 may comprise at least a second power unit for powering said delimbing and cutting means 110. The power unit in said UAV 100 may be electrical and/or an internal combustion engine. The power unit in said delimbing and cutting means 110 may be electrical and/or an internal combustion engine. The holding means 105 may be powered by its own power unit or powered from said UAV and/or said delimbing or cutting power unit.

In various example embodiments said delimbing and cutting means 110 is configured for delimbing a tree. The delimbing may be performed from top to bottom if said means configured for harvesting at least a portion of the tree is initially arranged above said tree to be harvested. The delimbing may be performed by one or a plurality of cutting means, snapping means, and/or shearing means. The cutting means may be by cutting chains and/or by rotary cutting disks. The cutting may be performed by a straight movement along said trunk of said means configured for harvesting at least a portion of a tree and/or by a serpentine movement along the trunk by said means configured for harvesting at least a portion of a tree.

In various example embodiments said delimbing and cutting means 110 may be configured to be in direct communication with a remote operator and/or a remote base station 120 or indirect communication via said UAV 100 with a remote operator and/or a base station 120. The indirect communication, i.e., the UAV 100 as access point, with said delimbing and cutting means 110 may be used if the same information is to be sent to both UAV 100 and said delimbing and cutting means 110. The UAV 100 may in various example embodiments work independently from a remote base station 120. The indirect communication may also be used if said UAV 100 is arranged in between said base station 120 and said delimbing and cutting means 110.

In various example embodiments said UAV and/or said means configured for harvesting at least a portion of a tree may comprise means configured for automatically locating a tree and/or a predetermined area to be harvested. Said means configured for automatically locating a tree and/or said predetermined area to be harvested may comprise at least a Global Navigation Satellite System, GNSS. Said means configured for automatically locating a tree and/or a predetermined area to be harvested may comprise at least one camera or optical sensor. Said means configured for automatically locating a tree and/or a predetermined area to be harvested may comprise at least a camera in combination with Artificial intelligence or machine learning algorithms for speeding up the detection of a suitable area to arrange said means configured to cut a tree trunk.

Now returning to FIG. 1 where the UAV 100 is on its way to a tree 135b to be harvested. The tree 135b may be preselected, i.e., selected prior to arrival to the tree 135. Alternatively said tree 135b may be selected by the UAV 100 in combination with the base station 120 once the UAV 100 is at or near a position above said tree 135b. The selection may be performed by identifying a picture of the tree 135b from above with stored pictures in said control station 120 and by means of a selection algorithm select a tree for tree thinning purpose or other selection criteria.

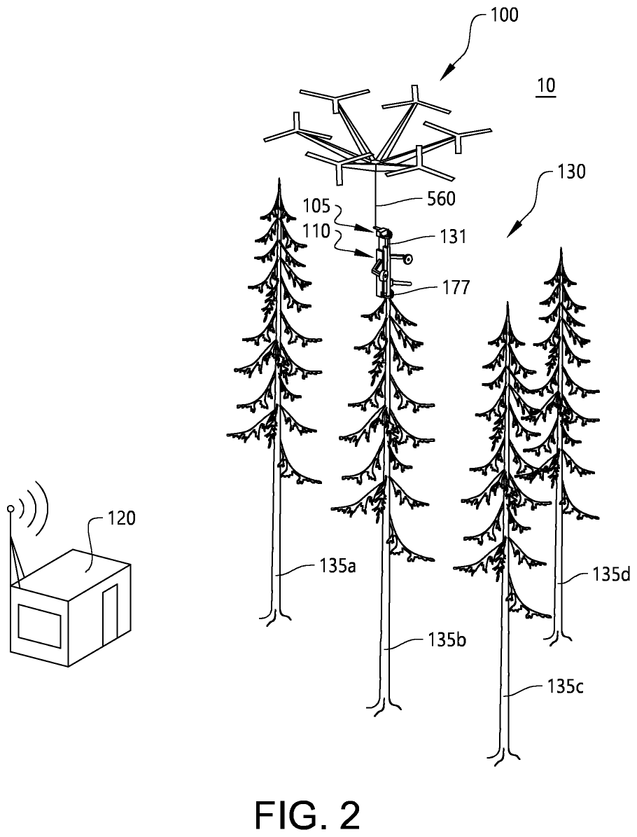

In FIG. 2-4 a forest 130 comprises four tree 135a, 135b, 135c, 135d, all of which may have equal or different tree parameters and/or growing conditions. The forest 130 may of course have a larger or smaller amount of trees than the depicted 4 trees as shown in FIG. 1-4. A tree to be harvested may be determined by at least one of said detected tree parameters and/or growing conditions. In various example embodiments the order of harvesting tree 135a, 135b, 135c, 135d may be selected out of minimizing a total harvesting time. In various example embodiments a particular tree may be selected because there is a demand of such tree parameters from a particular customer. In various example embodiments a particular tree may be selected to be harvested due to a particular tree thinning strategy, e.g., smallest or largest tree in a group of tree, diameter of said at least a portion of a tree, length of said at least a portion of a tree, tree species of said at least a portion of a tree and/or the weight of said at least a portion of a tree, dry content, twig-free, rootstock, density, rot, discolored, dead tree and/or insect infested. Tree parameters may be detected prior to arriving with the UAV 100 to the forest 130. This may be made manually and/or automatically. Manual detection may be made by human beings registering at least one tree parameter in a digital database. Automatic tree parameters may be made by a separate UAV and/or a land-based vehicle. Detection may be non-destructive and/or destructive.

Non-destructive methods may be made by visual inspection by a human being or by registering the tree by a suitable optical means such as a camera. Destructive detection may be made by removing a predetermined amount of a tree and analyzing it on site or at a remote site. A tree to be harvested may be selected depending on its distance to the final destination, e.g., choosing tree with a particular set of tree parameters as close to the final destination as possible. A tree to be harvested may be selected in order to maximize the value of the total amount of harvested tree in a particular time frame. A tree to be harvested may be selected in order to maximize the value of the remaining tree in the forest. A decision of how much of a particular tree to be harvested may be made depending on at least one tree parameter.

In a first example embodiment said delimbing and cutting means 110 is a delimbing tool only. This delimbing tool is used for delimbing trees autonomously and/or remotely from air according to the inventive method.

When delimbing is finished the UAV may lift up the delimbing tool and the tree will remain standing with its branches removed from its trunk.

The delimbing method may comprise the following steps: detecting by at least one sensor on a UAV a tree to be harvested, positioning a harvesting tool comprising delimbing means carried by said UAV, by using information from said at least one sensor, at a predetermined distance H above a tree top of the tree to be harvested, releasing the harvesting tool in a first mode from said UAV from said predetermined distance H above the top of the tree to be harvested, and setting said harvesting tool in a second mode when said harvesting tool is below the top of said tree to be harvested while said harvesting tool has a certain speed >0 in a downward direction, wherein said first and second mode differ with respect to a tree receiving area of said delimbing means in said harvesting tool.

In FIG. 1a the harvesting tool 105,110 is in a first mode with a relatively large tree receiving area 177. The tree receiving area is defined as the area in between delimbing means 518a, 518b and a frame structure 510 onto which said delimbing means are movably attached. When the harvesting tool 105, 110 is above the tree top 131 of a standing tree, a support structure 530 provided in a top portion 580 of the harvesting tool 105, 110 is provided in a first position. The support structure has an attachment point 540 for a cord provided between said harvesting tool and the UAV 100. The support structure may be an elongated rod or similar having the capability to handle the total weight of the harvesting tool 105, 110. As depicted in FIG. 1 the support structure is extending in a direction out from the frame structure 510 in a direction in which a stem of the tree is to be fed through the harvesting tool 105, 110 when a tree is to be delimbed. The positioning of the attachment point 540 in said support structure 530 when said harvesting tool 105, 110 is positioned above the tree top 131 may be in the mass center of the harvesting tool 105, 110. If providing the attachment point in the mass center of the harvesting tool the harvesting tool will hang beneath said UAV 100 in essentially vertical direction. In various example embodiments said attachment point 540 may be positioned in the rotation centre of the harvesting tool when said harvesting tool is above the tree top 131. When the attachment point for the attachment point for the cord is in the rotation centre of the harvesting tool, said tool may have one and the same location of the tree receiving area 177 independent of the rotation of the harvesting tool 105, 110. If not arranging the attachment point in the rotation centre of the tool, i.e., in the middle of the tree receiving area, the tree receiving area will move around with respect to a tree top, which may make the attachment of the harvesting tool 105, 110 to said tree top 131 of a standing tree much more difficult. In various example embodiments said mass centre and said rotation centre of the tool are essentially overlapping each other so that the tool is hanging below said UAV in a vertical manner and have the tree receiving area 177 in the same position independent of the rotation of the harvesting tool 105, 110. The support structure is movably arranged to said top portion of the harvesting tool 105, 110. The movement may be a sliding movement, tilting movement and/or rotating movement so as to move the attachment point 540 from a position above the tree receiving area 177 and/or mass centre to a position above an area which is outside of said tree receiving area and/or mass centre of the harvesting tool 105, 110

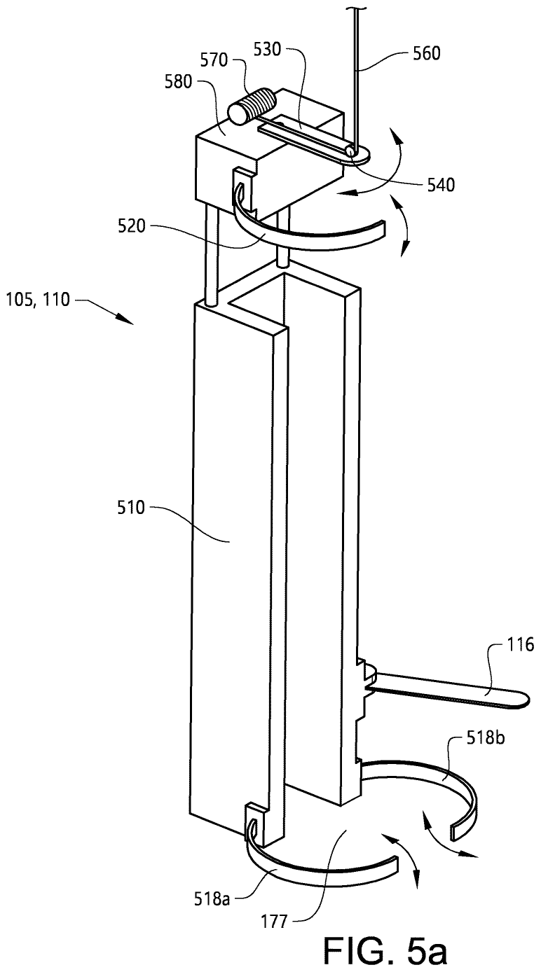

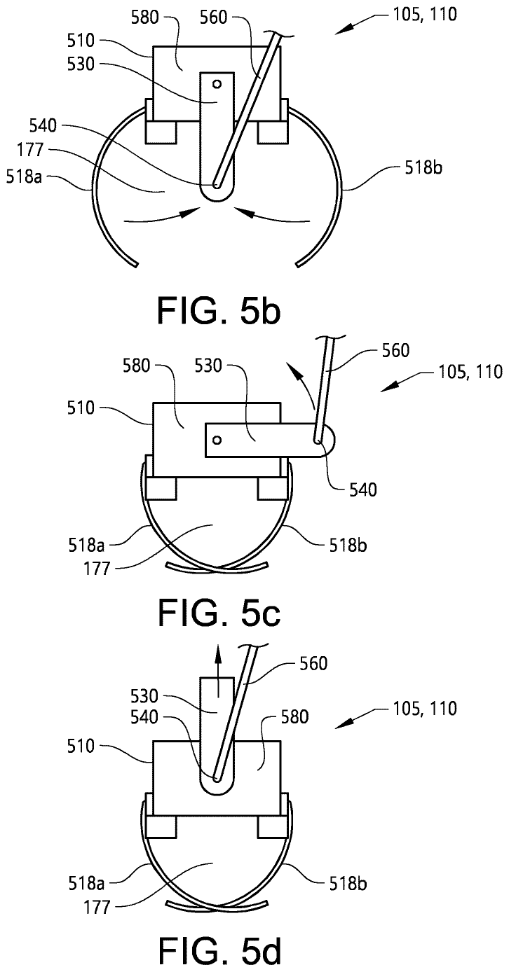

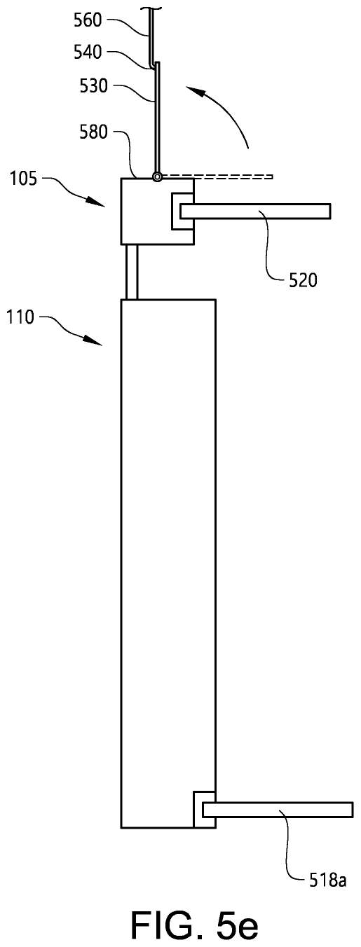

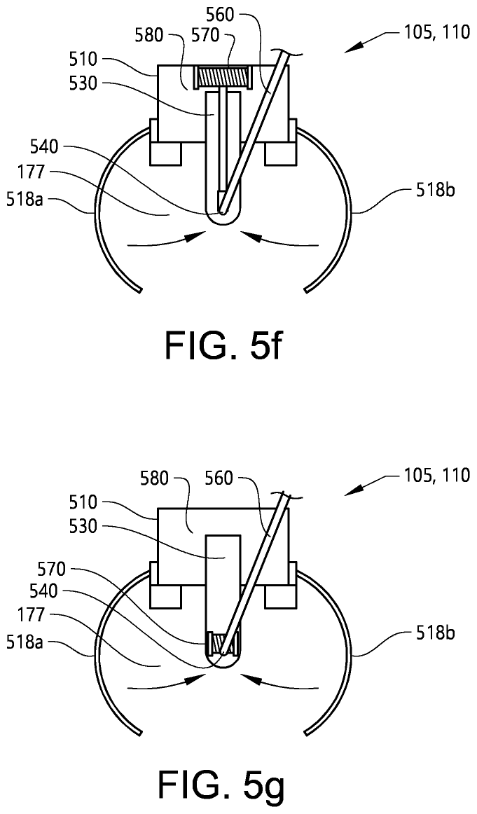

FIG. 5a depicts a perspective view of another example embodiment of a harvesting tool 105, 110. Here a winch 570 is provided on the top portion 580 of the harvesting tool 105, 110. The cord 560 goes through said attachment point 540 on said support structure 530 and thereafter to the UAV. The winch 570 is configured for spooling in or out said cord and thereby decreasing or increasing the distance between said harvesting tool 105, 110 and said UAV 100. In FIG. 5a a single holding means 520 is used. The attachment point is provided above the tree receiving area 177 when said delimbing means 518a, 518b is in an open position. FIG. 5b depicts a top view of another example embodiment of a harvesting tool 105, 110. Here it is evident that the attachment point 540 for the cord 560 is provided centered above the tree receiving area 177. In FIG. 5b the delimbing means 518a, 518b are in an open position.

In FIG. 2, which is after said delimbing and cutting means 110 has been dropped from the UAV 100, a tree top 131 of a standing tree is above said delimbing and cutting means 110. A top portion of the tree trunk is within the tree receiving area 177 of said delimbing and cutting means 110. At this moment the tree receiving area 177 may be switched from said first mode, with said relatively large tree receiving area 177, to said second mode with a relatively small tree receiving area 177. The smaller tree receiving area 177 may be adapted to the diameter of the tree trunk. The means for delimbing 518a, 518b may be resiliently attached to said tree trunk and be configured to adapt its tree receiving area to the changing diameter as the delimbing tool is moved downwards along the tree trunk.

When the harvesting tool 105, 110 is provided above the tree top 131, as depicted in FIG. 1, a support structure 530 comprising an attachment point 540 for a cord connectable between the UAV 100 and said harvesting tool 105, 110 is in a first position. With said support structure 530 in a first position said attachment point 540 is above the tree receiving area 177, see FIG. 5b.

When the harvesting tool 105, 110 is having a top portion of the tree trunk within the tree receiving area as depicted in FIG. 2, said support structure is set in a second position as depicted in any one of FIG. 5c-5d. In FIG. 5c the support structure 530 has been rotated to the second position. the rotational axis may be provided on the top portion 580. In FIG. 5d the support structure 530 has been slid to the second position. Here the sliding movement is along the elongated support structure. The sliding may be on a rail or similar. In FIG. 5e the support structure has been tilted to the second position. The tilting mechanism may be a hinge. The tilting may be initiated by releasing a pure mechanical tilt stop. Alternatively the support structure may be held in the first position by an electromagnetic force, which when released will let the support structure automatically in its second position. The sliding motion in FIG. 5d or rotational motion in FIG. 5c may be motorized. As can be seen from FIGS. 5c, 5d and FIG. 5e the second position of the support structure removes not only the attachment point away from the area above the tree receiving area 177 but also the support structure itself. By setting the support structure in the second position the support structure 530 will not be in the way of the stem of the tree to be delimed. The movement of the support structure from said first position to said second position may be synchronized with the movement of the delimbing means 518a, 518b, i.e., when the tree receiving area goes from open to closed, said support structure moves from said first to second position. In various embodiments said support structure may be set in a second position later than said delimbing means 518a, 518b are closed due to the fact that there is a distance between said delimbing means and said support structure 530. The delimbing means are provided in the lower portion of the harvesting tool 105, 110 whilst said support structure is provided in the upper portion of the support structure. The longer the harvesting tool 105, 110 the longer the distance between said delimbing means 518a, 518b and said support structure 530. The top of the tree is also relatively flexible and therefore not an acute problem for the delimbing process. However, as the tool travels down on the stem of the tree the stem will be bigger and less flexible. At a certain point said support structure needs to be removed from the first position from the area above the tree receiving area 177 in order not to hinder or slow down the delimbing process. As the harvesting tool is guided by the stem of the tree when delimbing, there is no need for supporting and/or balancing the tool with the support structure in the first position.

FIG. 5f and FIG. 5g depict two alternative arrangements of the winch 570. In FIG. 5f the winch is provided on the top portion 580 of the harvesting tool at a distance from the support structure 530 as well as the attachment point 540. In FIG. 5g the winch 570 is provided on the support structure 530 which may be on the attachment point or at a distance from the attachment point. In yet an alternative embodiment the UAV is provided with the winch and the cord is fixedly attached to the attachment point. In still another example embodiment both the harvesting tool 105, 110 has a winch and the UAV has a winch coupled to one and the same cord 560.

The support structure 530 may be an arm movably arranged to the top portion of the harvesting tool 105, 110.

In FIG. 2 delimbing and cutting means 110 at least a portion of a tree is on its way downwards along the tree trunk of the selected tree 135b. A tree top 131 is above the tree receiving area 177 of the harvesting tool 105, 110. At this position the tree receiving area 177 may switch from a first mode with a large tree receiving area to a second mode with a smaller tree receiving area, which smaller area may be adapted to embrace resiliently on the tree trunk in order to efficiently delimb the same. Said smaller area in said second mode may be configured to adapt automatically to the increasing diameter of the tree trunk as the means for harvesting at least a portion of a tree is moving downwards on said tree trunk. The tree receiving area 177 may be varied for both delimbing means and holding means in said harvesting tool 105, 110. When the harvesting tool has a predetermined portion of the tree top 131 within said tree receiving area 177 said support structure may start moving from a first position in which said attachment point is above the tree receiving area to a second position in which the attachment point is above an area outside the tree receiving area as depicted in FIG. 5 c-e. A trigger for start moving the support structure 530 may be a certain time after the top portion of the tree has been detected to be within said tree receiving area 177. The movement may be motorized. In an alternative embodiment said support structure 530 may be forced out from the tree receiving area by the tree trunk. When the support structure is in its first position, said attachment point 540 is above said tree receiving area 177. The attachment point may be provided in the center of mass of said harvesting tool 105, 110. By providing said attachment point 540 for said single cord between said harvesting tool 105, 110 and said UAV 100, said harvesting tool may hang under said UAV in a perfectly vertical manner, which may provide for an easy attachment of the harvesting tool 105, 110 onto said tree and stable delimbing of the same. As soon as the harvesting tool is attached to the top of the tree, said tool will be forced along the tree trunk. The harvesting tool 105, 110 will start its journey downward the tree to be delimed in a vertical position and will continue its fall essentially in a vertical direction guided by the trunk of the tree while said limbs of the tree are removed from its trunk.

The upper portion 580 may be defined as a position on the harvesting tool above the mass center in a vertical direction. A lower portion may be defined as a position below the mass center in a vertical direction.

In various example embodiments said delimbing and cutting means 110 may be a pure delimbing device without cutting means 116 or a delimbing device with cutting means 116.

In various example embodiment the harvesting tool 105, 110 may also comprise means for holding 105 the tree trunk for transportation away from its original location. The means for holding 105 may in a first embodiment be in a single unit together with said delimbing and cutting means 110. In another embodiment as depicted in FIG. 2-4 said means for holding 105 and said delimbing and cutting means 110, which optionally may comprise a means for cutting said tree trunk, may be separable from each other. The means for holding 105 and said delimbing and cutting means 110 may be connectable to each other via at least one winch mechanism as depicted in FIG. 2-4. Alternatively, said means for holding 105 and said delimbing and cutting means 110 may be completely separable from each other, i.e., without any wires or rods in between them when they are removed from each other. Said delimbing unit may comprise means configured for moving said delimbing tool up and down along the tree trunk. The means configured for moving said delimbing tool up and down along the tree trunk may be in form of one or a plurality of motorized wheels resiliently attached to the tree trunk, which wheel(s) are configured for making traction against the outer surface of the tree trunk for allowing movement of said delimbing tool upwards and downwards said tree trunk. Said motorized wheels may be autonomously and/or remotely operated.

In case of a delimbing and cutting means 110 and means for holding 105 said tree trunk which are separable to each other, two different delimbing scenarios may arise. In a first case, said delimbing and cutting means 110 may be dropped from said UAV together with said holding means 105 at a predetermined height H above the tree top 131. When the tree top 131 is detected to be within said tree receiving area 177, as depicted in FIG. 2, said delimbing and cutting means 110 may be released from said holding means 105. Said holding means 105 may be attached to said tree trunk at a position relatively close to the tree top 131, which position is determined to be safe as a lifting position of the tree trunk to be cut at a predetermined position. In a second embodiment only said delimbing and cutting means 110 is dropped from said holding means 105 at a predetermined height H above the tree top 131. When the delimbing and cutting means 110 has the tree top within its tree receiving area 177 said delimbing tool is switched from the first mode with the larger tree receiving area to the second mode with the smaller tree receiving area 177. The holding means 105 may be lowered from the UAV 100 as the delimbing tool is delimbing the tree or when said delimbing tool 100 has finished the delimbing.

The height H at which said harvesting tool is dropped with said delimbing means in said first mode of the tree receiving area 177 may be at least 0.1 m, 0.5 m, 1 m, 2 m or 3 m. One or a plurality of tree parameters may determine the height H. Such determining tree parameters may for instance be tree type or tree height. Growing conditions may also influence the choice of height H such as tree density around said tree to harvest, distance to next neighbor tree etc. In various example embodiments said height H may be a few cm, for instance when the tree is young and/or easy to delimb such as pine. In various example embodiments said height H may be several meters, for instance when the tree is old and/or relatively difficult to delimb such as birch. Larger older trees of particular species may require a relatively high height H in order to allow for gravity delimbing by knives provided on said delimbing delimbing and cutting means 110.

A relative position of a tree top and said UAV and/or said harvesting tool may be detected by at least one sensor attached to said UAV and/or said harvesting tool.

The UAV 100 and/or said harvesting tool 105, 110 may comprise 3 or more optical devices. It should also be understood that the optical devices may be unevenly distributed in many different configurations. For instance, a bracket may be provided between two motor support arms and one or a plurality of optical devices may be provided on said bracket. A first optical device may have a first field of view, a second optical device may have a second field of view, and a third optical device may have a third field of view. The first, second and third field of view may have a common overlapping volume. The UAV 100 may further comprising a control unit configured for creating a stereo image by combining at least one pair of images from any two of said first, second or third optical devices and wherein the first field of view, the second field of view and the third field of view are mainly in a direction in parallel with the yaw axis of said UAV pointing in a direction towards ground and any two of said first, second or third field of views are overlapping with each other in a focus plane. Stereo camera pairs may be used in computer vision to create a three-dimensional model of the surrounding environment. One requirement for such a system is for the cameras to be spaced apart from each other so that there is a measurable difference in the image seen by each camera, thereby allowing ranges in depth to be detected and quantified. The relative position and orientation of the two cameras may typically be rigidly maintained in order for stereo algorithms to work correctly.

A first camera may be separated from the second camera by a predetermined distance. The first camera may include a first field of view while the second camera may include a second field of view. An overlapping field exists where the first field of view overlaps the second field of view. The stereo camera pair may be configured to determine distances of objects present in the captured imagery. The overlapping portion of the images from each camera may be analyzed by comparing corresponding features and determining separation distances associated with at least some of the corresponding features. For example, the images may include a first image captured by the first camera and a second image captured by the second camera. However, the images may include a first image captured by the first camera and a second image captured by the first camera at a later point in time, such as a next frame of imagery. Said tree top 131 may be detected by means of at least one out of at least three different stereo images. At least one detector may detect when at least a portion of a tree is within said tree receiving area of said harvesting tool. Said detector may be said stereo camera on another optical device provided on said UAV and/or said harvesting tool. In case no tree is detected within said tree receiving area said release of said harvesting tool may be autonomously stopped. An automatic stop may be performed if failure of detection of any tree within said tree receiving area is the case after a certain period of time after release of the harvesting tool from the UAV and/or within a predetermined speed interval of said harvesting tool without detection of any tree top within said tree receiving area 177 of said harvesting tool.

The tree receiving area 177 in said first mode may be at least twice as big as said tree receiving area 177 in said second mode. In various example embodiments said tree receiving area 177 in said first mode may be at least 10 times as big as said tree receiving area 177 in said second mode.

Said harvesting tool 105, 110 may be attached to said UAV 100 with at least two cables each provided with a winch mechanism during said first and second mode. Said harvesting tool may be moving in a direction essentially in parallel with the tree trunk of the tree to be harvested with a speed greater than 1m/s when said switching from said first mode to said second mode is performed. In an alternative embodiment, said switching may be performed when the speed of said harvesting tool in a downward direction is greater than 2 m/s.

In FIG. 2 delimbing and cutting means 110 at least a portion of a tree is on its way downwards along the tree trunk of the selected tree 135b. A tree top 131 is above the tree receiving area 177 of the harvesting tool 105, 110. At this position the tree receiving area 177 may switch from a first mode with a large tree receiving area to a second mode with a smaller tree receiving area, which smaller area may be adapted to embrace resiliently on the tree trunk in order to efficiently delimb the same. Said smaller area in said second mode may be configured to adapt automatically to the increasing diameter of the tree trunk as the means for harvesting at least a portion of a tree is moving downwards on said tree trunk. The tree receiving area 177 may be varied for both delimbing means and holding means in said harvesting tool 105, 110.

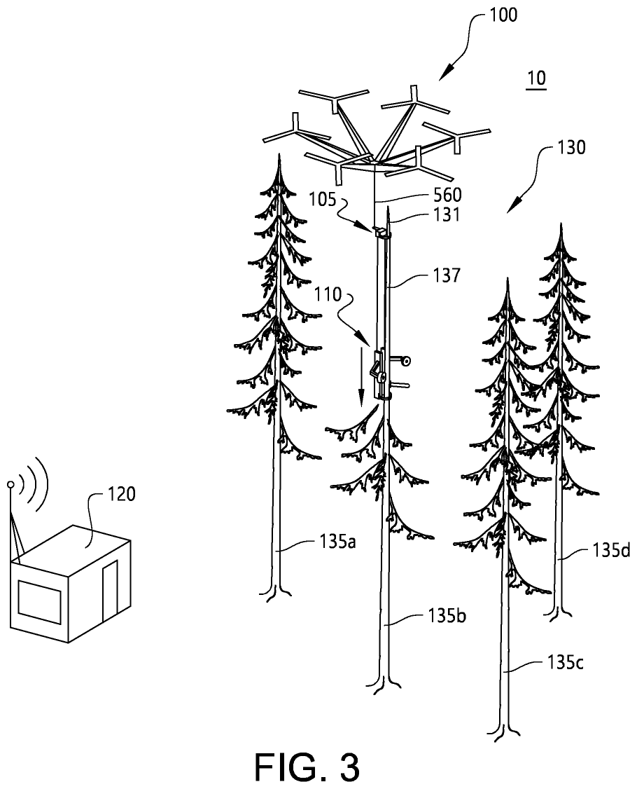

In FIG. 3 the autonomously controlled delimbing and cutting means 110 has been moved a distance down from said at least one means for gripping 105 said tree trunk. On its way down said delimbing and cutting means 110 also has delimbed the tree 135b leaving a bare tree trunk 137 without twigs and limbs. The powering of said delimbing and cutting means 110 may be provided by said UAV 100 or by a power unit in said delimbing and cutting means 110. In case of power supplied from said UAV to said delimbing and cutting means 110 said power may be delivered via one or a plurality of power cables arranged on between said UAV 100 and said delimbing and cutting means 110. A power unit in said delimbing and cutting means 110 may be one or a plurality of battery packs. In various example embodiments a first battery pack may be used for communication with the UAV 100 and/or a base station 120. A second battery pack may be used for moving said delimbing and cutting means 110 up/down on a tree trunk.

Instead of harvesting trees and/or bushes (tree) by means of cutting at least a portion of said tree, said tree may be removed from ground with at least a portion of its root system. This removal may be made by using the UAV as removal means, i.e., gripping a tree and using the upward traction power of the UAV for removing the tree from ground. This technique may only be used for small tree, for instance when an invasive art is to be removed from a particular area at an early stage for not causing damage on the remaining portion of the forest.

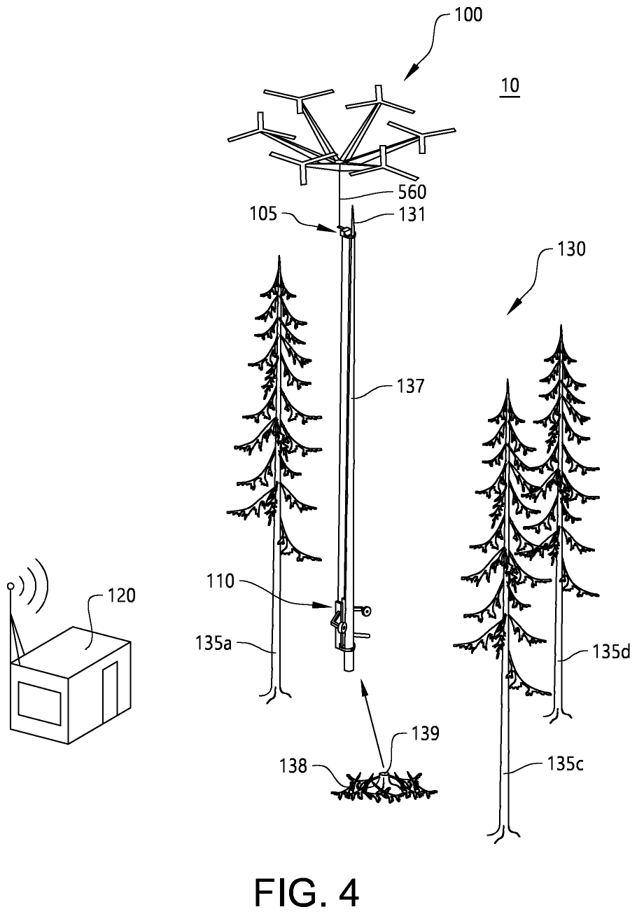

In various example embodiments means for gripping 105 said tree trunk and said delimbing and cutting means 110 is not separating from each other during the delimbing of the tree as depicted in FIGS. 3 and 4 but will follow each other during the delimbing of the tree downwards the tree trunk as one unit.

In FIG. 4 the tree 135b has been delimbed into a bare tree trunk 137, harvested and on its way to a location away from the original location of the tree. What is left of the original tree 135b at its original location is a pile of limbs 138 and a tree stump 139. In the depicted example embodiment said delimbing and cutting means 110 is still arranged on said tree trunk when the tree is transported away from the original location of the tree. In various example embodiments it is provided means configured for directing said remotely and/autonomously UAV 100 with said at least a portion of a tree to a final destination where said final destination is depending on said detected tree parameters. In various example embodiments a first type of tree species may be transported to a first final destination whereas a second type of tree species may be transported to a second final destination. The final destination may have a first set of tree parameters, final destination B may have a second set of tree parameters and final destination C may have a third set of tree parameters. Said first, second and third set of tree parameters may be different. Tree parameters may for instance be a diameter of said at least a portion of a tree, length of said at least a portion of a tree, tree species of said at least a portion of a tree and/or the weight of said at least a portion of a tree, dry content, twig-free, rootstock, density, rot, discolored, dead tree, insect infested. At least one of said final destinations A, B or C may be an intermediate storage on ground. At least one of said final destinations A, B or C may be a mobile storage, for instance a timber truck.

In various example embodiments the final destination A may be for timber having a length within a predetermined interval. The final destination B may be for timber having a predetermined weight per unit of timber. The final destination C may be for rotten tree, discolored tree, dead tree and/or insect infested tree.

In various example embodiments the final destination A may be allocated with timber having a first set of tree parameters and a requirement to be filled with timber prior to a final destination B which may have the same tree parameters but will be filled with timber later in the tree harvesting process. It may be that the final destination A is close to a road or at a timber truck, whereas final destination B may be an intermediate storage closer to the harvesting area compared to final destination A and far away from any available road.

In various example embodiments the first final destination A may be for timber to be used as pulp. The second final destination B may be for building material, such as plank. The third final destination C may be for biomass material.

FIG. 5 illustrates an example embodiment of delimbing and cutting means 110

Said first and second movable curved fixing/delimbing arms 114a, 114b may be set to any position between a fully open position and fully closed position in order to allow to embrace a tree trunk and also to fixing the same. Said fixing/delimbing arms may have a sharp edge on its top portion and/or its bottom portion for delimbing the tree as the means configured for harvesting at least a portion of the tree moves along the trunk of said tree. Said delimbing and cutting means 110 comprises a cutter 116. The cutter may be in the form of an electrically driven or internal combustion engine driven chain saw. The chain saw may be arranged movable in said delimbing and cutting means 110 in order to cut a tree while said means is in a fixed position on said trunk of the tree. In various example embodiments said delimbing and cutting means may only be a delimbing tool without any cutter for cutting the tree trunk.

In various example embodiments said harvesting tool 105, 110 may be made of two separable parts, a first part that is mainly configured for holding the tree 105 and a second part 110, capable of moving up and down along the trunk of the tree, which can delimb and/or cut the tree.

Said means for holding 105 may change its position onto said tree trunk during cutting, delimbing, harvesting, transporting and/or debarking said tree trunk.

In various example embodiments of the present invention it provides for a method of delimbing a tree by the gravity force induced by said harvesting tool when released from said UAV. Different releasing height and/or different weight of the harvesting tool may be chosen for different types of trees.

In various example embodiments the support structure 530 is autonomously controlled. A camera or similar sensor may detect the position of the harvesting tool with respect to the top of the tree and trigger the movement of said support structure from said first to said second position. Alternatively said support structure is synchronized with the movement of the delimbing means.

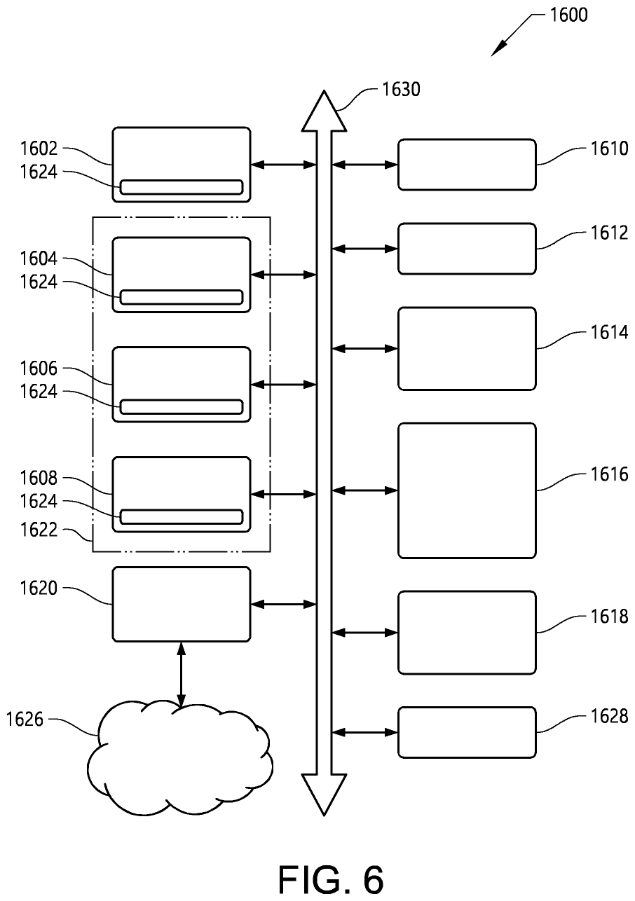

FIG. 6 illustrates a block diagram of an example machine 1600 upon which any one or more of the techniques (e.g., methodologies) discussed herein may perform. Examples, as described herein, may include, or may operate by, logic or a number of components, or mechanisms in the machine 1600. Circuitry (e.g., processing circuitry) is a collection of circuits implemented in tangible entities of the machine 1600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1600 follow.

In alternative embodiments, the machine 1600 may operate as a standalone device or may be connected (e.g., networked) to other machines. In a networked deployment, the machine 600 may operate in the capacity of a server machine, a client machine, or both in server-client network environments. In an example, the machine 1600 may act as a peer machine in peer-to-peer (P2P) (or other distributed) network environment. The machine 1600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

The machine (e.g., computer system) 1600 may include a hardware processor 1602 (e.g., a central processing unit (CPU), a graphics processing unit (GPU), a hardware processor core, or any combination thereof), a main memory 1604, a static memory (e.g., memory or storage for firmware, microcode, a basic-input-output (BIOS), unified extensible firmware interface (UEFI), etc.) 1606, and mass storage 1608 (e.g., hard drive, tape drive, flash storage, or other block devices) some or all of which may communicate with each other via an interlink (e.g., bus) 1630. The machine 1600 may further include a display unit 1610, an alphanumeric input device 1612 (e.g., a keyboard), and a user interface (UI) navigation device 1614 (e.g., a mouse). In an example, the display unit 1610, input device 1612 and UI navigation device 1614 may be a touch screen display. The machine 1600 may additionally include a storage device (e.g., drive unit) 1608, a signal generation device 1618 (e.g., a speaker), a network interface device 1620, and one or more sensors 1616, such as a global positioning system (GPS) sensor, compass, accelerometer, gyro, optical sensors or other sensor. The machine 1600 may include an output controller 1628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1602, the main memory 1604, the static memory 1606, or the mass storage 1608 may be, or include, a machine readable medium 1622 on which is stored one or more sets of data structures or instructions 1624 (e.g., software) embodying or utilized by any one or more of the techniques or functions described herein. The instructions 1624 may also reside, completely or at least partially, within any of registers of the processor 1602, the main memory 1604, the static memory 1606, or the mass storage 1608 during execution thereof by the machine 1600. In an example, one or any combination of the hardware processor 1602, the main memory 1604, the static memory 1606, or the mass storage 1608 may constitute the machine readable media 1622. While the machine readable medium 1622 is illustrated as a single medium, the term “machine readable medium” may include a single medium or multiple media (e.g., a centralized or distributed database, and/or associated caches and servers) configured to store the one or more instructions 1624.

The term “machine readable medium” may include any medium that is capable of storing, encoding, or carrying instructions for execution by the machine 1600 and that cause the machine 1600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1624 may be further transmitted or received over a communications network 1626 using a transmission medium via the network interface device 1620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi(R), IEEE 802.16 family of standards known as WiMax(R)), IEEE 802.15.4 family of standards, peer-to-peer (P2P) networks, among others. In an example, the network interface device 1620 may include one or more physical jacks (e.g., Ethernet, coaxial, or phone jacks) or one or more antennas to connect to the communications network 1626. In an example, the network interface device 1620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1600, and includes digital or analog communications signals or other intangible medium to facilitate communication of such software. A transmission medium is a machine readable medium.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1-23. (canceled)

24. A system for remotely and/or autonomously delimbing a tree from air, said system comprising:
a remotely and/or autonomously controlled Unmanned Aerial vehicle, UAV,
a harvesting tool comprising a frame structure with at least one movably delimbing means configured for delimbing at least a portion of a tree,
a cord attached between said UAV and said harvesting tool,
a winch system, attached to said UAV and/or said harvesting tool, configured for spooling in and/or out said cord and thereby decreasing or increasing the distance between said UAV and said harvesting tool,
a base station configured for communicating with said UAV and/or said harvesting tool (105, 110),
a sensor attached to said UAV and/or said harvesting tool for detecting a tree, and
an attachment point for said cord provided on a support structure,
wherein said support structure is slidably, tiltably or rotatably arranged on an upper portion of said frame structure, said support structure is configured to be slided, tilted or rotated between at least a first position where said attachment point is provided in a position above a tree receiving area of the harvesting tool and a second position where said attachment point is away from said position above the tree receiving area of the harvesting tool,
wherein the tree receiving area refers to an area in between open or closed delimbing means and said frame structure.

25. The system according to claim 24, wherein said tree receiving area is configured to be set in an open position when above the top of a tree and configured to be set in a closed position when said harvesting tool is below the top of the tree.

26. The system according to any one of claim 24, wherein said support structure is configured to be moved from said first to said second position when said tree receiving area is changed from an open to a closed position.

27. The system according to claim 24, wherein said harvesting tool is configured to delimb the tree by gravity.

28. The system according to claim 24, wherein said harvesting tool comprises means for cutting a tree trunk.

29. A method for remotely and/or autonomously delimbing a tree from air, said method comprising the steps of:
detecting a tree to be delimbed by a sensor provided on a remotely and/or autonomously controlled Unmanned Aerial vehicle, UAV;
providing a remotely and/or autonomously controlled harvesting tool attached underneath said UAV via a cord, said harvesting tool comprising a tree receiving area configured for being set in an open position when above a top of the tree to be delimbed and configured for being set in a closed position when said harvesting tool is below said top of the tree to be delimbed, wherein the tree receiving area refers to an area in between open or closed delimbing means and a frame structure of said harvesting tool;
providing a winch system to said UAV and/or said harvesting tool, configured for spooling in and/or out said cord attached between said UAV and said harvesting tool for decreasing or increasing the distance between said UAV and said harvesting tool; and
moving a support structure, provided on said harvesting tool, comprising an attachment point for said cord, between at least a first and second position depending on the relative position between the top of a tree to be delimbed and said harvesting tool and/or depending on a vertical speed of the harvesting tool.

30. The method according to claim 29, wherein said support structure is rotatably, linearly or tiltably movable relative to said harvesting tool.

31. The method according to claim 29, wherein said support structure is configured for being moved from said first to said second position when said tree receiving area is changed from an open to a closed position.

32. The method according to claim 29, wherein said attachment point is provided essentially in a mass center and/or in an area above the center of the tree receiving area of the harvesting tool when said support structure is in said first position.

33. The method according to claim 29, further comprising the step of cutting a tree trunk by means of a cutting device provided on said frame structure of said tree harvesting tool.

34. The method according to claim 33, further comprising the steps of:
securing said harvesting tool to said cut and delimbed tree; and
transporting said cut tree away from its original location.

35. A harvesting tool configured for hanging under an Unmanned Aerial Vehicle, UAV, and configured for at least delimbing a standing tree from air, said harvesting tool comprising:
a frame structure having an upper portion; at least one delimbing means movably arranged to said frame structure and adjustable by means of at least one actuator means;
a control system connected to said at least one actuator means to control the same; and
a support structure attached to said upper portion of said frame structure, said support structure comprising an attachment point for a cord, where said cord is attachable between said harvesting tool and an Unmanned Aerial Vehicle, (UAV),
wherein said support structure is rotatably, slidably or tiltably arranged relative to said frame structure between at least a first and second position,
wherein said first position of said support structure is configured for providing said attachment point in a position above a tree receiving area defined as an area in between open or closed delimbing means and said frame structure, and
wherein said second position of said support structure is configured for providing said attachment point away from said position above said tree receiving area.

36. The harvesting tool according to claim 35, wherein said tree receiving area is set to an open or a closed position depending on the distance between a top of a tree to be delimbed and said harvesting tool and/or depending on a vertical speed of the harvesting tool.

37. The harvesting tool according to claim 35, wherein said first position of said support structure is configured for providing said attachment point essentially in a mass center of the harvesting tool.

38. The harvesting tool according to claim 35, further comprising a cutting device attached to a lower portion of said frame structure and configured for cutting a tree trunk of said delimbed tree.

39. The harvesting tool according to claim 35, further comprising a winch mechanism attached to an upper portion of said frame structure and configured for rolling in or out a cord attached to an Unmanned Aerial Vehicle, UAV, in order decrease or increase respectively the distance between said harvesting tool and said UAV.

40. A computer program comprising program code means for performing the method of claim 29.

42. The method according to claim 29, wherein one or more of the recited steps are implemented via at least one control unit containing one or more computer processors.
